(19) United States
(12) Patent Application Publication
(10) Pub. No.: US 2026/0016781 A1
(43) Pub. Date: Jan. 15, 2026

(54) IMAGE FORMING APPARATUS

(71) Applicants: Takao YOSHINUMA, Kanagawa (JP); Takumi MIYAGAWA, Kanagawa (JP); Tomoaki HIROOKA, Kanagawa (JP)

(72) Inventors: Takao YOSHINUMA, Kanagawa (JP); Takumi MIYAGAWA, Kanagawa (JP); Tomoaki HIROOKA, Kanagawa (JP)

(73) Assignee: Ricoh Company, Ltd., Tokyo (JP)

(21) Appl. No.: 19/257,770

(22) Filed: Jul. 2, 2025

(30) Foreign Application Priority Data
Jul. 9, 2024 (JP) 2024-110421

(51) Int. Cl. G03G 15/00

(52) U.S. Cl. CPC G03G 15/5054; G03G 15/6558; G03G 2215/00599

(57) ABSTRACT

An image forming apparatus includes an image former, a conveyor, and circuitry. The image former forms an image on a medium as an image-forming operation. The conveyor retains mediums for a preset retention number in the conveyor and sequentially conveys the medium to the image former based on a conveyance order of the medium determined by the preset retention number. The circuitry controls the image former and the conveyor to perform the image-forming operation, determines whether to reduce productivity of the image former based on a change in environment of the image-forming operation during the image-forming operation, and determines whether to reduce the preset retention number in response to a determination of reducing the productivity.

### CROSS-REFERENCE TO RELATED APPLICATIONS

This patent application is based on and claims priority pursuant to 35 U.S.C. § 119 (a) to Japanese Patent Application No. 2024-110421, filed on Jul. 9, 2024, in the Japan Patent Office, the entire disclosure of which is hereby incorporated by reference herein.

### BACKGROUND

### Technical Field

Embodiments of the present disclosure relate to an image forming apparatus.

### Related Art

In an image forming apparatus that continuously performs image formation on both sides of multiple sheet-shaped media, an interleaf method is known that switches the order of image formation on both sides (front and back sides) of the media to prevent the productivity of the image forming process from decreasing, in other words, to reduce the time to complete the image forming process. The image forming apparatus changes a set temperature of a fixing temperature in accordance with a type of medium and employs a technology to reduce an image forming time when a specific continuous image-forming operation of forming images on multiple media is performed when two or greater than types of media are mixed.

### SUMMARY

In an embodiment of the present disclosure, an image forming apparatus includes an image former, a conveyor, and circuitry. The image former forms an image on a medium as an image-forming operation. The conveyor retains mediums for a preset retention number in the conveyor and sequentially conveys the medium to the image former based on a conveyance order of the medium determined by the preset retention number. The circuitry controls the image former and the conveyor to perform the image-forming operation, determines whether to reduce productivity of the image former based on a change in environment of the image-forming operation during the image-forming operation, and determines whether to reduce the preset retention number in response to a determination of reducing the productivity.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overall configuration of an image forming apparatus;

FIGS. 2A, 2B, 2C, and 2D are schematic diagrams each illustrating an operation of the image forming apparatus of FIG. 1, when the image forming apparatus performs an image forming process by a three-sheet interleaf operation;

FIG. 3 is a block diagram of a control system provided for the image forming apparatus of FIG. 1;

FIG. 4 is a functional block diagram of a controller provided for the image forming apparatus of FIG. 1;

FIGS. 5A, 5B, and 5C are diagrams each illustrating sheet conveyance control based on an interleaf conveyance method;

FIGS. 6A, 6B, and 6C are diagrams each illustrating sheet conveyance control based on an interleaf method to control a timing at which sheets are switched back and conveyed to reverse front sides and back sides of the sheets when images are formed on both sides of the sheets;

FIG. 7 is a flowchart of sheet conveyance control including change of the number of interleaf sheets when productivity is reduced; and

FIG. 8 is a flowchart of sheet conveyance control including change of the number of interleaf sheets when productivity is reduced, according to a modification of embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. Like reference signs are given to identical or corresponding components throughout the drawings and redundant description thereof may be omitted.

### Embodiment of Image Forming Apparatus

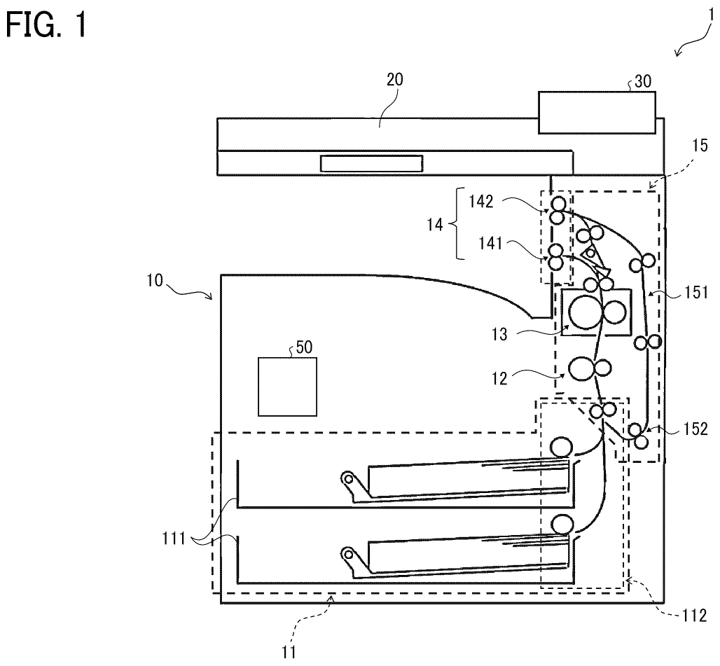

A description is given below of an image forming apparatus according to embodiments of the present disclosure with reference to the drawings. FIG. 1 is a diagram illustrating an overall configuration of a multifunction peripheral (MFP) 1 as an image forming apparatus according to an embodiment of the present disclosure. As illustrated in FIG. 1, the MFP 1 is an image forming apparatus capable of performing an image forming process by a so-called electrophotographic method. Since the electrophotographic method is a known technology, detailed description thereof is omitted.

The MFP 1 includes at least an apparatus body 10, an image reader 20, an operation panel 30, and a controller 50. The apparatus body 10 includes at least a medium loading unit 11, a transfer device 12, and a fixing device 13 that constitute an image former, a medium ejection unit 14, a conveyor 15 that constitutes a medium conveyor, and a controller 50.

The medium loading unit 11 includes at least medium storage trays 111 that store sheets P as sheet-shaped media as objects on which images are formed, and a sheet conveyance adjuster 112 including pickup rollers that separate an uppermost sheet P of the multiple sheets P stacked on the medium storage tray 111 and conveys the uppermost sheet P to the conveyor 15. The medium storage tray 111 may include multiple trays in accordance with, for example, the size of the sheets P.

The sheet conveyance adjuster 112 adjusts a timing at which conveyance of the sheet P is started such that the sheet P reaches the transfer device 12 and the fixing device 13 in accordance with a timing at which an image is transferred to the sheet P, based on an instruction of the controller 50 to cause the MFP 1 to perform the image forming process on the surface of the sheet P.

The transfer device 12 as an image transferor transfers an image formed on the sheet P based on an instruction input to the MFP 1 to perform the image forming process, in other words, image data designated by image formation job data. The image transferred by the transfer device 12 is a visualized image obtained by attaching developer (such as toner) onto a latent image formed on the photoconductor based on the image data. Accordingly, the transfer device 12 transfers the visualized image obtained by attaching the developer onto the sheet P. At this time, the operation timing and the transfer temperature of the transfer device 12 are adjusted by the controller 50 and are controlled such that the image is favorably transferred to the sheet P.

The fixing device 13 as a fixing device fixes the image transferred onto the sheet P to the sheet P. The fixing temperature of the fixing device 13 is also adjusted by the controller 50.

The medium ejection unit 14 includes an ejector 141 and a reversing unit 142. The ejector 141 serves as a sheet ejection port through which the sheet P, on which an image has been formed only on the front side of the sheet P, is ejected. The reversing unit 142 reverses and conveys the sheet P to switch back the sheet P, which requires image formation on the back side of the sheet P, to a reverse conveyor 151.

The conveyor 15 serves as a medium conveyor and includes at least the reverse conveyor 151 and a reverse conveyance adjuster 152. The reverse conveyor 151 serves as a conveyor that returns the sheet P to the transfer device 12 to form an image on the back side of the sheet P switched back by the reversing unit 142. When an image is formed on the back side of the sheet P, the reverse conveyance adjuster 152 adjusts the conveyance timing of the sheet P to the transfer device 12 in accordance with the timing at which the image is transferred to the target sheet P in the transfer device 12 based on the instruction of the image forming process input to the MFP 1.

The image reader 20 is a unit that reads an image from a medium placed on a document tray and generates image data. The configuration, function, and operation of the image reader 20 are known. Therefore, detailed description of the image reader 20 is omitted.

The operation panel 30 serves as an operational panel that displays a screen for inputting an operation instruction to the MFP 1 and setting data for the operation. On the operation panel 30 of the MFP 1, operation conditions and settings employed for the image forming process, which is described below, can be changed as appropriate. The operation panel 30 receives, for example, an input of a set number of interleaf sheets to be described below.

When the number of interleaf sheets is input on the operation panel 30, the number of interleaf sheets is held in a number-of-interleaf sheet setting unit 502 described below, and the number of interleaf sheets is made available when an image formation controller 503 controls the image forming process

The controller 50 controls the overall operation of the MFP 1. The controller 50 is described in detail below.

### Overview of Operation of MFP 1

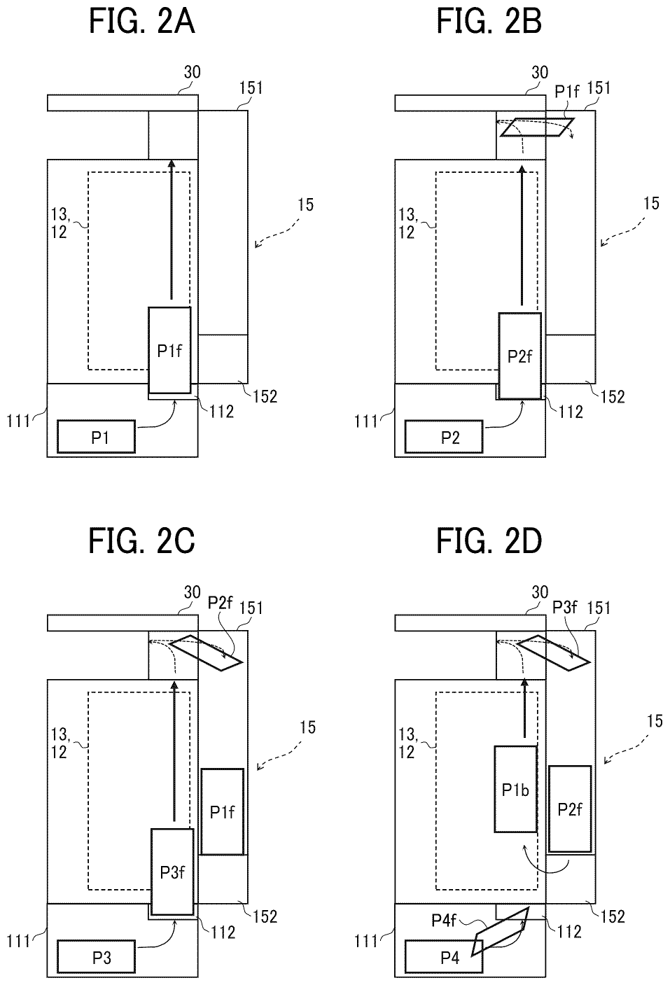

A description is given of an overview of the image forming process performed by the MFP 1. FIGS. 2A, 2B, 2C, and 2D are diagrams each illustrating a process of forming images on both sides (front and back sides) of the sheet P. The MFP 1 can control sheet conveyance based on the interleaf method. In other words, when the image forming process is continuously performed on both sides of the multiple sheets P, the MFP 1 changes the sheet conveyance order such that an image is formed on the front side of one sheet P among the multiple sheets P stacked on the medium storage tray 111, then, an image is formed on the back side of the one sheet P.

Accordingly, the MFP 1 temporarily causes multiple sheets P, on both sides of which images are to be formed, to be retained in the conveyor 15, changes the sheet conveyance order of the multiple sheets P, and controls the conveyance process for improving the productivity defined by the number of processes per unit time of the image forming process (the number of image forming processes). An interleaf operation in which the number of sheets P to be retained in the conveyor 15 (the number of interleaf sheets) is three is referred to as a three-sheet interleaf operation in the following description.

FIGS. 2A, 2B, 2C, and 2D are diagrams each illustrating the operation of the MFP 1 when the MFP 1 performs the image forming process by the three-sheet interleaf operation. For example, a description is given below of a case in which an instruction to perform a continuous double-sided image forming operation on multiple sheets P is given to the MFP 1. First, as illustrated in FIG. 2A, a first sheet P (sheet P1) is conveyed from the medium storage tray 111 to the conveyor 15, and an image is formed on the front side of the sheet P1, i.e., a sheet P1f, as a first face of the P1.

Next, as illustrated in FIG. 2B, the sheet P1 is switched back and conveyed to the reverse conveyor 151 to form an image on the back side of the sheet P1, i.e., a sheet P1b as a second face of the sheet P1. At this time, a second sheet P (sheet P2) is conveyed to the conveyor 15 from the medium storage tray 111, and an image is formed on the front side of the sheet P2, i.e., a sheet P2f.

Next, as illustrated in FIG. 2C, the sheet P2 is switched back and conveyed to the reverse conveyor 151 to form an image on the back side, i.e., a sheet P2b, of the sheet P2. Then, a third sheet P (sheet P3) is conveyed from the medium storage tray 111 to the conveyor 15, and an image is formed on the front side, i.e., a sheet P3f, of the sheet P3. At this time, the sheet P1 is retained in the reverse conveyance adjuster 152 and waits to be conveyed to the transfer device 12 until image formation on the sheet P3f is completed.

Subsequently, as illustrated in FIG. 2D, when the image formation on the sheet P3f is completed and the sheet P1b passes through the fixing device 13 and is switched back and conveyed to the reverse conveyor 151, the sheet P1 retained in the reverse conveyance adjuster 152 is conveyed to the transfer device 12 to form the image on the sheet P1b.

Subsequently, an image is formed on the sheet P1b, and the sheet P1 is ejected from the ejector 141.

Accordingly, the number of sheets P that are retained in the conveyor 15 of the MFP 1 is two, and a next sheet P is loaded from the medium storage tray 111.

Subsequently, as an operation similar to FIG. 2C, a sheet P4 is retained in the reverse conveyance adjuster 152 until the image forming process on the front side, i.e., a sheet P4f, of a fourth sheet P (sheet P4) is completed. After the image formation on the sheet P4f is completed, the sheet P2 is conveyed to the conveyor 15 such that an image is formed on the sheet P2b. Subsequently, repeating the above-described operations allows the continuous double-sided image formation to be performed. Accordingly, the number of double-sided image forming operations that can be completed per unit time can be increased. Thus, the productivity of the MFP 1 can be enhanced. As described above, in the case of the three-sheet interleaf operation, the order of image formation on both sides of the sheets P is changed when each of the three sheets P is retained in the conveyor 15.

For example, in the state of FIG. 2C, when an abnormality occurs in the operation of the MFP 1 and the operation is stopped, conveyance of the three sheets P that are retained in the conveyor 15 fails. Accordingly, the three sheets P need to be removed and discarded. Accordingly, as the number of retained sheets P increases, the time and effort increases when an abnormality occurs.

The number of interleaf sheets is determined by the length of the conveyance path in the conveyor 15 of the MFP 1, the size of the sheet P, i.e., the length of the sheet P on which images are formed in the conveyance direction, and a sheet interval, i.e., the interval between the sheets P that are continuously conveyed.

In the correlation between the length of the conveyance path and the size of the sheet P, as the number of allowable interleaf sheets is increased, the sheet interval can be shortened. As a result, the number of the sheets P on both sides of which images are formed increases, thus the productivity of the MFP 1 increases. In the present embodiment, the productivity is one of the indices represented by the number of the sheets P on which the image forming process can be completed per unit time and is an example of the processing capability of the MFP 1.

In the MFP 1, when the temperature of the transfer device 12 that performs the transfer process or the temperature of the fixing device 13 that performs the fixing process exceeds the upper limit of the temperature defined in the specifications, the image quality is degraded. For this reason, “productivity reduction operation” to maintain the image quality is performed.

As illustrated in FIG. 2C, when the operating environments of the image-forming operation changes while the image forming process is performed by the three-sheet interleaf operation, the productivity may need to be reduced. At this time, it is necessary to lengthen the time interval at which the image forming process is performed. For example, when it is necessary to reduce the productivity due to the temperature rise of the fixing device 13, the time interval of the image forming process is lengthened to reduce the number of image forming processes per unit time. For this reason, the conveyance control is performed to widen the sheet interval between the multiple sheets P. Specifically, the time for which the sheets P are retained and waiting to be conveyed in the reverse conveyance adjuster 152 is increased. Accordingly, the time in which three sheets P are continuously retained is longer. In such a condition, when an abnormality occurs in the MFP 1, it is necessary to discard the three sheets P.

By contrast, when the temperature of the fixing device 13 rises and the productivity needs to be reduced to prioritize the image quality, it is necessary to lengthen the sheet interval to wait for the fixing temperature to stabilize. At this time, it is sufficient that each of the sheets P is conveyed at a timing that meets the reduced productivity. For this reason, not setting a condition in which the maximum number of interleaf sheets that increases the productivity the most, which is determined by, for example, the size of the sheet P and the length of the conveyance path, does not become a bottleneck. Accordingly, even if the number of interleaf sheets is reduced, the image forming process that achieves the necessary productivity may be performed.

When an abnormality occurs in the MFP 1 in the above-described condition, the number of sheets P to be discarded can be reduced as compared with the case in which the number of interleaf sheets is not changed.

### Control Configuration of MFP 1

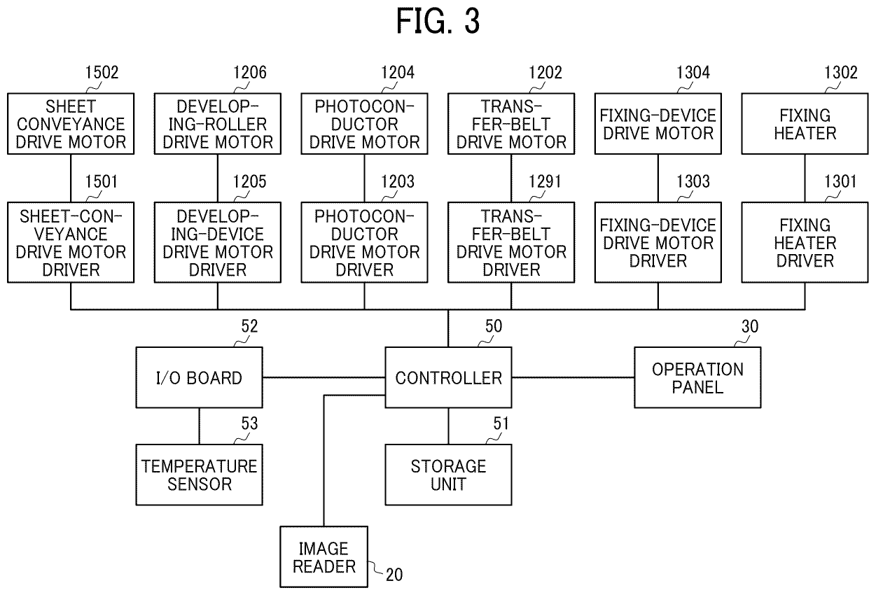

FIG. 3 is a block diagram of an example of a control system provided for the MFP 1. In FIG. 3, the controller 50 that serves as a controller includes a microcomputer including, for example, a central processing unit (CPU), a read-only memory (ROM), and a random-access memory (RAM). The controller 50 is connected to a storage unit 51, the operation panel 30, and an input and output (I/O) board 52 that serves as a temperature detection interface unit.

The controller 50 is also connected to a sheet-conveyance drive motor driver 1501, a developing-device drive motor driver 1205, a photoconductor drive motor driver 1203, a transfer-belt drive motor driver 1291, a fixing-device drive motor driver 1303, and a fixing heater driver 1301.

The I/O board 52 operates a temperature sensor 53 in response to an instruction from the controller 50, converts a temperature detection signal (detection voltage) of the temperature sensor 53 into a digital signal, and inputs the digital signal to the controller 50. The I/O board 52, the temperature sensor 53, and the controller 50 collectively serve as a temperature detector that detects the temperature inside the MFP 1.

For example, the temperature sensor 53 as the temperature detector detects the temperatures of the transfer device 12 and the fixing device 13 and notifies the controller 50 of the temperatures. The controller 50 determines whether to reduce the productivity based on the temperature data notified from the temperature sensor 53.

Multiple temperature sensors 53 may be installed in the MFP 1, and temperature detection signals from the multiple temperature sensors 53 may be converted into digital signals and input to the controller 50. Then, the controller 50 may calculate the average of the digital signals and use the average of the digital signals as input data of the detected temperatures. Alternatively, temperature detection signals from one or multiple temperature sensors 53 disposed in the apparatus body 10 of the MFP 1 may be converted into digital signals and input to the controller 50.

The developing-device drive motor driver 1205 controls power supply to a developing-roller drive motor 1206, which rotates a developing roller in a developing unit of each of image forming devices based on an instruction from the controller 50. By so doing, the developing-device drive motor driver 1205 rotates a developing sleeve of each of the developing rollers at a predetermined rotation speed or stops the rotation.

The sheet-conveyance drive motor driver 1501 drives and controls a sheet conveyance drive motor 1502, which rotationally drives multiple conveyance roller pairs related to sheet conveyance disposed in the conveyor 15, based on instructions from the controller 50. The photoconductor drive motor driver 1203 drives and controls a photoconductor drive motor 1204, which rotationally drives the multiple photoconductors of the image former, based on an instruction from the controller 50.

The transfer-belt drive motor driver 1291 drives and controls a transfer-belt drive motor 1202, which rotates a driving roller to move an intermediate transfer belt of the image former in a circumferential direction, based on an instruction from the controller 50. The fixing-device drive motor driver 1303 drives and controls a fixing-device drive motor 1304, which rotationally drives a drive roller in the fixing device 13, based on an instruction from the controller 50. The fixing heater driver 1301 turns on and off power supply supplied to a fixing heater 1302, which serves as a heat source of a heating roller and a pressure heating roller in the fixing device 13, based on an instruction from the controller 50.

The storage unit 51 is, for example, a semiconductor memory or a storage device using a storage medium such as a magnetic disk or an optical disk, and stores data of temperatures detected by the temperature sensor 53 or setting data of various control conditions such as a “threshold temperature Tth” described below. Data in the storage unit 51 can be written and read by the controller 50.

The memory in the controller 50 may be employed instead of the storage unit 51.

The operation panel 30 is disposed on a part of the apparatus body 10. The operation panel 30 is disposed on a part of the apparatus body 10 that is easy for the operator to see and operate. The operation panel 30 includes various switches and buttons that can be operated by the operator, and a touch-panel type operation panel in which a touch panel is superimposed on a liquid crystal display panel. The controller 50 can display various kinds of data on the touch-panel type operation panel of the operation panel 30. Accordingly, the operator can, for example, view the display to perform an input operation, select an operation mode, and set various kinds of data. Thus, the operator can input the data to the controller 50. Such a configuration as described above allows the operation panel 30 to serve as an input device that enables the operation mode to be selected and input.

The MFP 1 may be an image forming apparatus that prints a print job (a group of data including an image forming command and setting data necessary for image forming) transmitted from a host apparatus such as a personal computer. In such a case, for example, a display, a keyboard, and a pointing device of the host apparatus may be employed together with or instead of the operation panel 30 to function as the input device. In this case, the controller 50 of the MFP 1 displays necessary data on the display of the host apparatus via a communication device, and the operator can select an operation mode and set various data using, for example, the keyboard, the pointing device of the host apparatus, and send the data to the controller 50 of the MFP 1.

The controller 50 reads and executes a predetermined control program. By so doing, the controller 50 controls the above-described units and devices. At the same time, the controller 50 executes various controls and processes related to the change of the operation modes according to embodiments of the present disclosure described below.

### Functional Configuration of MFP 1

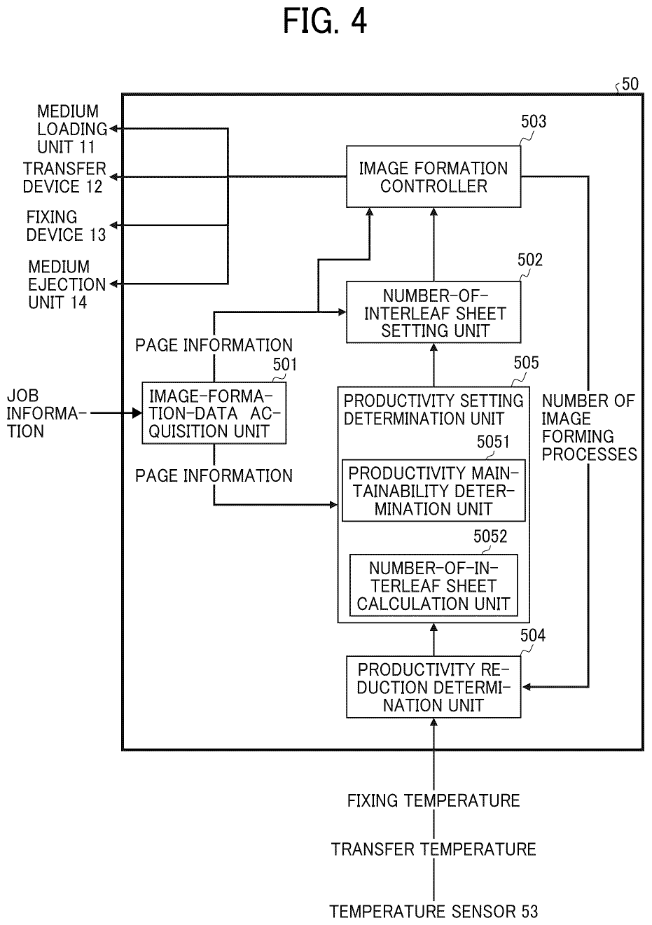

Next, a description is given of a functional configuration of the controller 50 provided for the MFP 1. FIG. 4 is a functional block diagram of the controller 50. As illustrated in FIG. 4, the controller 50 includes an image-formation-data acquisition unit 501, the number-of-interleaf sheet setting unit 502, an image formation controller 503, a productivity reduction determination unit 504, and a productivity setting determination unit 505.

The image-formation-data acquisition unit 501 acquires job data input from outside of the MFP 1 or the operation panel 30. The image-formation-data acquisition unit 501 notifies page data included in the job data to the number-of-interleaf sheet setting unit 502, the image formation controller 503, and the productivity setting determination unit 505. The page data includes, for example, the number of interleaf sheets (the set number of sheets P to be retained), together with, for example, size information of the number of sheets P subjected to the image forming process, and whether duplex printing is performed.

The number-of-interleaf sheet setting unit 502 sets the number of interleaf sheets notified from the image-formation-data acquisition unit 501 and notifies the image formation controller 503 of the number of interleaf sheets. When the number-of-interleaf sheet setting unit 502 receives a change notification of the number of interleaf sheets from the productivity setting determination unit 505, the number-of-interleaf sheet setting unit 502 sets the number of interleaf sheets indicated by the change notification and notifies the image formation controller 503 of the number of interleaf sheets.

The image formation controller 503 controls the operation of the medium loading unit 11, the transfer device 12, the fixing device 13, and the medium ejection unit 14 based on the set number of interleaf sheets and the notified page data, and causes the image former to perform the image forming process.

The productivity reduction determination unit 504 as a productivity reduction determiner determines whether to reduce the productivity based on, for example, the number of image forming processes (cumulative number of image forming processes) notified from the image formation controller 503, the temperature (transfer temperature) of the transfer device 12 notified from the temperature sensor 53, and the temperature (fixing temperature) of the fixing device 13. In the present embodiment, the productivity is an index represented as the number of processes per unit time of the image forming process. The cumulative number of processes, the transfer temperature, and the fixing temperature, for example, correspond to indices indicating the operation status of the MFP 1 that varies during the execution of the image forming process.

For example, when the fixing temperature exceeds a predetermined threshold value, the productivity reduction determination unit 504 determines whether to adjust the conveyance interval (inter-sheet distance) between the sheets P and adjusts the conveyance speed to reduce the number of image forming processes per unit time to prevent the temperature from rising. The reduction of the productivity is treated as reduction of copies per minute (CPM), which is the number of copies per unit time, when the MFP 1 performs the copying process. When the MFP 1 performs printing process, the reduction of the productivity is treated as reduction of pages per minute (PPM), which is the number of pages, i.e., printing processes, per unit time.

The productivity setting determination unit 505 as a productivity setter includes a productivity maintainability determination unit 5051 as a productivity maintainability determiner and a number-of-retained sheet calculation unit 5052. When the productivity reduction determination unit 504 determines that the productivity needs to be reduced, the productivity maintainability determination unit 5051 determines whether the productivity is maintainable after the productivity is reduced even if the number of interleaf sheets is reduced. The number-of-retained sheet calculation unit 5052 calculates the number of interleaf sheets to maintain the productivity after the productivity is reduced. The calculated number of interleaf sheets is notified to the number-of-interleaf sheet setting unit 502.

### Embodiment of Conveyance Control Process

A description is given of a conveyance control process of the MFP 1, according to an embodiment of the present disclosure. The conveyance control process according to the present embodiment is a process of controlling switching of the conveyance order using the interleaf method.

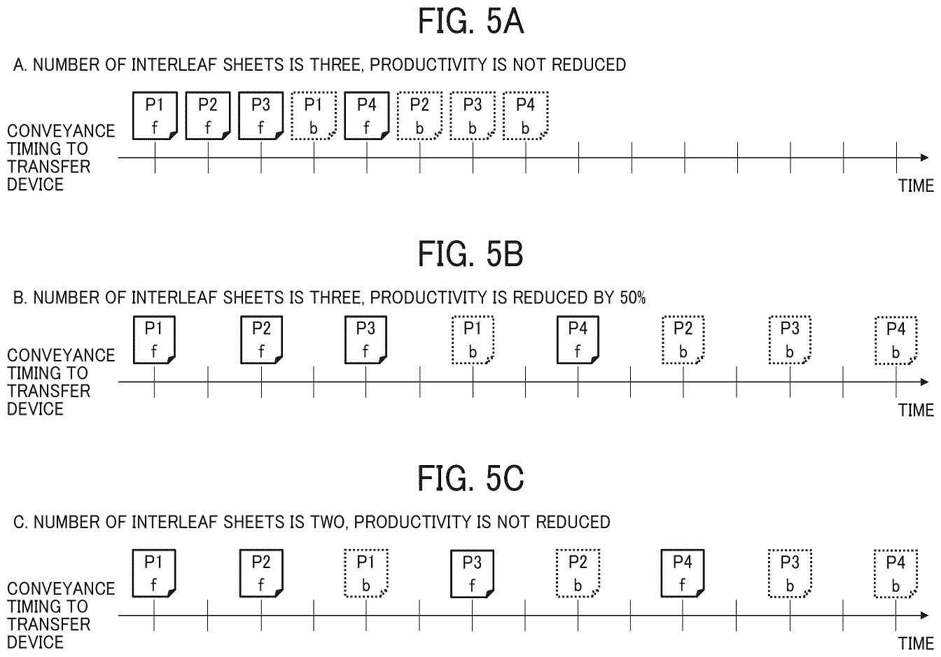

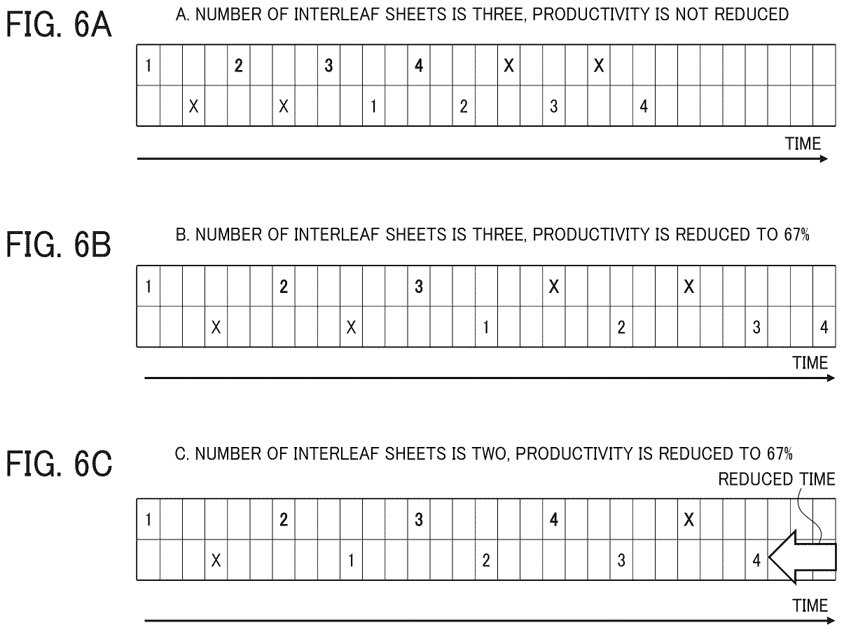

First, the relation between the number of interleaf sheets and the reduced productivity is described with reference to FIGS. 5A, 5B, 5C, 6A, 6B, and 6C. FIGS. 5A, 5B, and 5C are diagrams each illustrating conveyance control of sheets P based on an interleaf conveyance control to control a timing at which four sheets P are conveyed to the transfer device 12 when images are formed on both sides of four sheets P. For example, FIG. 5A is a diagram illustrating a case in which the number of interleaf sheets is set to three and the productivity is not reduced. FIG. 5B is a diagram illustrating a case in which the number of interleaf sheets is set to three and the productivity is reduced by about 50%. FIG. 5C is a diagram illustrating a case in which the number of interleaf sheets is set to two and the productivity is not reduced.

In FIGS. 5A, 5B, and 5C, the horizontal axis represents the time flow of the image forming process performed on the sheets P1, P2, P3, and P4. When FIG. 5A and FIG. 5B are compared, the time interval between the adjacent sheets P (such as between the sheets P1f and P2f) continuously conveyed in FIG. 5B is longer than in FIG. 5A. This is because in FIG. 5B, the productivity is reduced to 50% with respect to FIG. 5A. The conveyance interval between the sheets P is doubled to reduce the productivity to 50%.

Accordingly, in FIG. 5B, the conveyance interval (interval on the time axis) between the sheets P is doubled compared to FIG. 5A.

When the case in which the productivity is reduced to 50% as illustrated in FIG. 5B with respect to FIG. 5A is compared with the case in which the number of interleaf sheets is set to two as illustrated in FIG. 5C, the timings at which the image forming process on both sides of the four sheets P is completed are substantially similar. In the case of FIG. 5B, in which even if a condition to reduce the productivity is met, the number of retained sheets P in the MFP 1 can be reduced, and the number of sheets P to be discarded can be reduced when an abnormality occurs.

In order to reverse and convey the sheets P to control the interleaf operation of the MFP 1, it is necessary to switch back and convey the sheet P after an image is formed on the front side of the sheet P. For this reason, the conveyance interval between the sheets P is set in consideration of the time needed to switch back and convey the sheets P.

FIGS. 6A, 6B, and 6C are diagrams each illustrating sheet conveyance control based on the interleaf method to control timings at which the sheets P are switched back and conveyed to reverse the front sides and the back sides of the sheets P when images are formed on both sides of the sheets P. In FIGS. 6A, 6B, and 6C, rectangular columns in the upper row indicate timings at which images are formed on the front sides of the sheets P. Rectangular columns in the lower row also indicate timings at which images are formed on the back sides of the sheets P.

The horizontal axis in FIGS. 6A, 6B, and 6C is the time axis, and rectangles arranged in the time axis direction indicate time intervals equal to the conveyance intervals of the sheets P. If the conveyance interval based on the size of the sheet P is one rectangle, as illustrated in FIG. 6A, when the duplex printing is performed, after an image is formed on a sheet P, the next sheet P is conveyed with the conveyance interval of one sheet P.

In the conveyance control described with reference to FIGS. 6A, 6B, and 6C, when the productivity is reduced, the number of interleaf sheets is updated to an optimum setting. By so doing, the time necessary for the image forming process to complete can be shortened while conditions of the reduced productivity are met.

The numbers illustrated in the rectangles in FIGS. 6A, 6B, and 6C indicate the order of the sheets P to be subjected to the image forming process. For example, “1” indicates a timing at which an image is formed on the sheet P1.

For example, as illustrated in FIG. 6A, the sheet P1 is being switched back and conveyed until the time when an image is formed on the sheet P1f, and subsequently, an image is formed on the sheet P2f. At this time, the sheet P3 is not yet loaded. No image is formed on the back side of the sheet P1, which is indicated by “X” in FIG. 6A.

Subsequently, after an image is formed on the sheet P2f, an image is not formed on the back side of the sheet P2 until an image is formed on the sheet P3f, similar to the case of P1 as described above.

Subsequently, after an image is formed on the sheet P3f, an image is formed on the sheet P1b until an image is formed on the sheet P4f. Then, the sheet P1 is ejected. Subsequently, the sheet P4 is loaded into the conveyor 15, and an image is formed on the sheet P4f.

Subsequently, images are formed in the order of the sheet P2b, the sheet P3b, and the sheet P4b. Thus, the image formation is completed on both sides of the four sheets P1, P2, P3, and P4 by the three-sheet interleaf operation.

FIG. 6B illustrates a case in which the productivity is reduced to 67% compared with the image forming process of FIG. 6A. FIG. 6B schematically illustrates a state in which the sheet interval is widened to control the sheet conveyance by the three-sheet interleaf operation while the productivity is reduced.

As illustrated in FIG. 6B, as compared with FIG. 6A, the sheet P1 is being switched back and conveyed until an image is formed on the sheet P1f, then an image is formed on the sheet P2f. Thus, the time interval until the sheet P2 is loaded is longer. In the subsequent conveyance, the interval between the sheets P is similarly increased.

FIG. 6C is a diagram illustrating a state in which the productivity is reduced to 67% compared with the image forming process of FIG. 6A, and the conveyance control by the two-sheet interleaf operation is performed. Also, in FIG. 6C, the sheet interval is increased as compared with FIG. 6A to cope with the reduction of the productivity.

As illustrated in FIG. 6C, in the case of the two-sheet interleaf operation, after an image is formed on the sheet P2f, the sheet P2 is conveyed to the reverse conveyor 151. Then, an image is formed on the sheet P1f. Subsequently, an image is formed on the sheet P3f. Then, an image is formed on the sheet P2b. If the number of sheets P on which images are to be formed is greater than four, the MFP 1 alternately and sequentially performs image formation on the front and back sides of the sheets P while maintaining the number of interleaf sheets.

When FIG. 6C is compared with FIG. 6B, as illustrated in FIG. 6C, changing the number of interleaf sheets when reducing the productivity can shorten the time necessary until the image is formed on the final sheet P. Accordingly, when the productivity is reduced to prevent, for example, the transfer temperature and the fixing temperature from increasing to maintain the image quality, the number of interleaf sheets during the image forming process is changed. By so doing, the productivity can be prevented from decreasing or the productivity can be enhanced.

As described above, when the productivity is reduced, the number of interleaf sheets is changed. By so doing, whether the time necessary until the image is formed on the final sheet P can be shortened is determined by conditions related to the image forming process such as the length of the conveyance path, the sheet interval, i.e., the time necessary to switchback the sheet P, and the linear velocity.

### Procedure of Conveyance Control Process

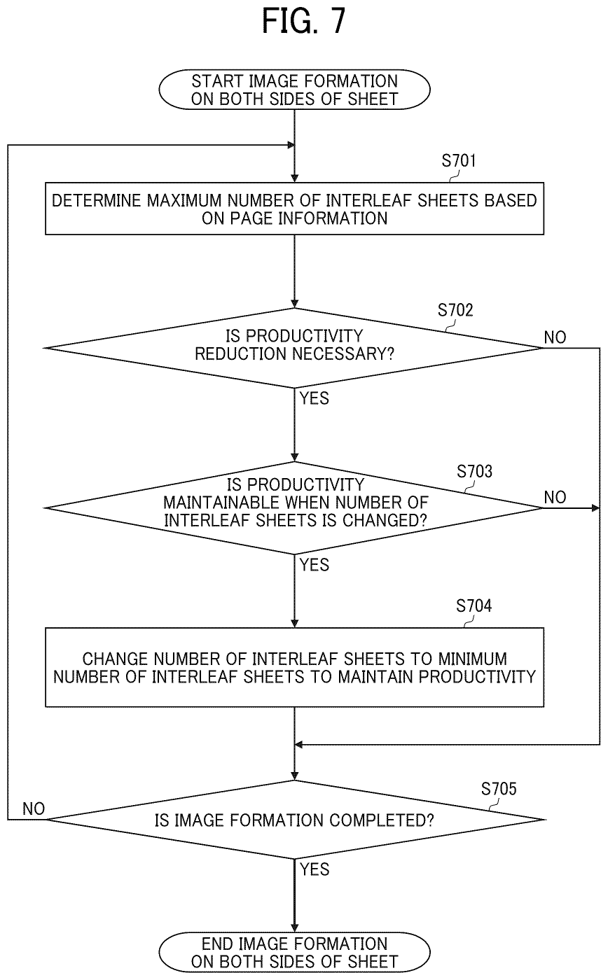

Next, a description is given of a conveyance control process with reference to FIG. 7. The conveyance control process includes setting the minimum number of interleaf sheets that can achieve reduced productivity when the productivity is reduced after the image forming process on both sides of the sheets P is started.

In the MFP 1, the controller 50 that sets the number of interleaf sheets acquires page information from job data including data whether image forming process on both sides of the sheets P is to be performed. Based on the page information, the controller 50 determines and sets the maximum number of interleaf sheets to perform the conveyance control process (step S701). The controller 50 uniquely determines the maximum number of interleaf sheets from the length of the conveyance path, the linear velocity of the sheet conveyance, the productivity data (the number of sheets to be printed per unit time), and the sheet size determined by the page information of MFP 1, which are determined in advance.

Subsequently, the controller 50 determines whether to reduce the productivity (step S702). If the image forming process is a copying process, the controller 50 determines whether the reduction of CPM is necessary in step S702. If the image forming process is a printing process, the controller 50 determines whether the reduction of PPM is necessary in step S702.

Examples of factors for determining whether to reduce the productivity in step S702 include the condition of the fixing device 13. The controller 50 determines whether to reduce the productivity depending on the condition of the fixing device 13 such as the temperature of the fixing device 13, i.e., the temperature acquired by a sensor such as a thermistor or a thermopile, or the heat storage condition of the fixing device 13. For example, when the controller 50 determines whether to reduce the productivity based on the temperature of the fixing device 13, as a simplest method, the controller 50 acquires the temperature of the fixing device 13 via the temperature sensor 53 of the fixing device 13 at the timing at which the fixing process is performed in the image forming process. The temperature of the fixing device 13 at the above-described timing is referred to as “acquired temperature T1”. The temperature of the fixing device 13 that is used as a threshold value when the productivity is reduced is referred to the threshold temperature Tth.

In this case, if the acquired temperature T1 is not equal to or higher than the threshold temperature Tth (NO in step S702), the controller 50 loops the processing until the image forming process, which is performed with the maximum number of interleaf sheets determined in step S701 (NO in step S705) defined by the job data, is completed.

Alternatively, the controller 50 may estimate the temperature of the fixing device 13 at a future time based on the heat storage state of the fixing device 13. By so doing, the controller 50 may set the condition to determine whether to reduce the productivity is necessary. For example, the heat is excessively stored inside the fixing device 13 when the image forming process is performed for a long time immediately before. For this reason, the controller 50 can determine whether excessive temperature rise is likely to occur in subsequent printing operation due to excessive heat accumulation inside the fixing device 13. Accordingly, the controller 50 can determine whether to reduce the productivity based on, for example, the usage condition of the fixing device 13 and the change of environment of the image-forming operation of the MFP 1.

In addition, examples of the factors to decide whether the productivity needs to be reduced include temperature rise inside the image former. Similar to the case of the fixing device 13, the controller 50 acquires the temperature of the transfer device 12, and when the temperature of the transfer device 12 exceeds a threshold value, the controller 50 determines that the productivity needs to be reduced. In this case, the controller 50 may set the sheet interval to a value at which the transfer device 12 can be stopped between the sheets P to lower the temperature of the fixing device 13.

When the acquired temperature T1 is lower than the threshold temperature Tth, the controller 50 cancels the productivity reduction and performs the image forming process based on a predetermined productivity.

If the acquired temperature T1 is equal to or higher than the threshold temperature Tth in step S702 (YES in step S702), the controller 50 determines the productivity reduction rate based on, for example, the temperature condition. In the present embodiment, the productivity reduction rate may be determined based on the fixing temperature to reduce CPM, and the transfer temperature to change the setting of the sheet interval.

Subsequently, the controller 50 determines whether the productivity is maintainable even when the number of interleaf sheets is reduced (step S703). The determination process in step S703 is performed, for example, as follows.

First, a description is given below of conditions for determining number of interleaf sheets (N).

Setting of Productivity Condition k [ppm]

In a case in which the productivity is rated by the number of sheets subjected to the image forming process per 60 seconds, when the image forming process is performed on both sides of a sheet P, a time necessary from a timing at which transfer of an image to a first side of the sheet P is started to a timing at which transfer of an image to a second side of the sheet P is started, is set as “T_duplex” (seconds). At this time, whether the interleaf operation can be performed is determined by whether a following formula is satisfied: T_duplex≤T_paper×(2×N−1), whereas T_paper (second) is a total time in which the sheet P moves a distance including the sheet length and the sheet interval, i.e., a period of time from a timing at which conveyance of the leading end of a sheet P is started to a timing at which conveyance of the leading end of a next sheet P is started under a similar productivity condition k [ppm].

When the formula of “T_duplex≤T_paper×(2×N−1)” is transformed to a formula corresponding to N, which is the number of interleaf sheets, “N≥{(T_duplex/T_paper)+1}/2” is obtained. The number of interleaf sheets can be calculated as the minimum natural number satisfying N using this formula.

The productivity after the productivity is reduced with respect to the original productivity rate is expressed as x [%]. If the productivity is not reduced, x is 100%, i.e., a productivity reduction rate. For example, if the productivity in a typical operating condition is 60 ppm, x=50% when the productivity is reduced to 30 ppm.

The productivity is expressed by the number of sheets subjected to the image forming process per 60 seconds. Therefore, the productivity can be expressed by a formula of “T_paper [sec]=(60 [sec]/k [ppm])/(x [%]/100)”.

From the above conditions, the controller 50 can determine, from the relation between the productivity and the productivity reduction rate, whether the productivity for printing is maintainable even when the number of interleaf sheets is reduced.

If the controller 50 determines in step S703 that the productivity is not maintainable even if the number of interleaf sheets is reduced (NO in step S705), the controller 50 loops the processing until the image forming process defined in the job data is completed by the setting of the maximum number of interleaf sheets determined in step S701 (NO in step S705).

In step S703, when the controller 50 determines that the productivity is maintainable even if the number of interleaf sheets is reduced (YES in step S703), the controller 50 changes the number of interleaf sheets to the minimum number of interleaf sheets that can achieve a productivity reduction rate in accordance with the formula “N≥{(T_duplex/T_paper)+1}/2” (step S704). Then, while performing the conveyance control based on the changed number of interleaf sheets, the controller 50 loops the processing until the image forming process defined in the job data is completed (NO in step S705). When the defined image forming process is completed (YES in step S705), the controller 50 completes the processing.

As described above, even when the productivity needs to be reduced during printing while the image forming process is performed, the controller 50 can temporarily stop loading the sheets P from the medium storage tray 111, eject the sheets P retained in the reverse conveyor 151 in advance to enlarge the sheet interval, change the number of interleaf sheets to a target number of interleaf sheets, and resume the image forming process. By so doing, the controller 50 can change the number of interleaf sheets while the image forming process is performed. Alternatively, the controller 50 may eject all the interleaf sheets currently being retained to outside the MFP 1, then resume the image forming process with the reduced number of interleaf sheets. When the productivity reduction is no longer necessary, the productivity may be returned to the original target productivity.

### Modification of Conveyance Control Process

Next, a description is given of a modification of the conveyance control process of the MFP 1. The conveyance control process described with reference to FIG. 7 is applicable to, for example, a case in which the temperature of the fixing device 13 is high after the end of a long-time continuous image forming process, and a subsequent image formation is started when a condition in which the productivity needs to be reduced, is satisfied. In the conveyance control process illustrated in FIG. 7, the controller 50 changes the number of interleaf sheets to the minimum number of interleaf sheets capable of achieving the necessary productivity from a first sheet P subjected to the image forming process. By so doing, the time of the entire image forming process can be shortened.

By contrast, in a case in which the productivity needs to be reduced while the image forming process is continuously performed and the number of interleaf sheets is changed to the minimum number of interleaf sheets capable of maintaining the necessary productivity when the productivity needs to be reduced, it is difficult to obtain the above-described effects. In other words, supply of the sheets P from the medium loading unit 11 is temporarily stopped to reduce the number of sheets P retained inside the MFP 1, the conveyance interval (sheet interval) of the sheets P is increased, and the sheets P retained in the conveyor 15 are ejected in advance. In this case, the supply of the sheets P is resumed after the sheets P are ejected. By so doing, it is necessary to switch the number of interleaf sheets to a target number of interleaf sheets. Thus, the printing time increases.

When the controller 50 switches the number of interleaf sheets while the image forming process is continuously performed, a shortened time period (first completion time) necessary to complete the image forming process when the number of interleaf sheets is switched to the minimum number of interleaf sheets capable of maintaining the necessary productivity is compared with a time period (second completion time) necessary to switch the number of interleaf sheets. At this time, the controller 50 may change the number of interleaf sheets only when the time necessary to complete the image forming process can be shortened.

The first completion time and the second completion time are determined based on printing conditions such as the linear velocity and the sheet size, necessary for the image forming process, the number of interleaf sheets, and the productivity reduction rate.

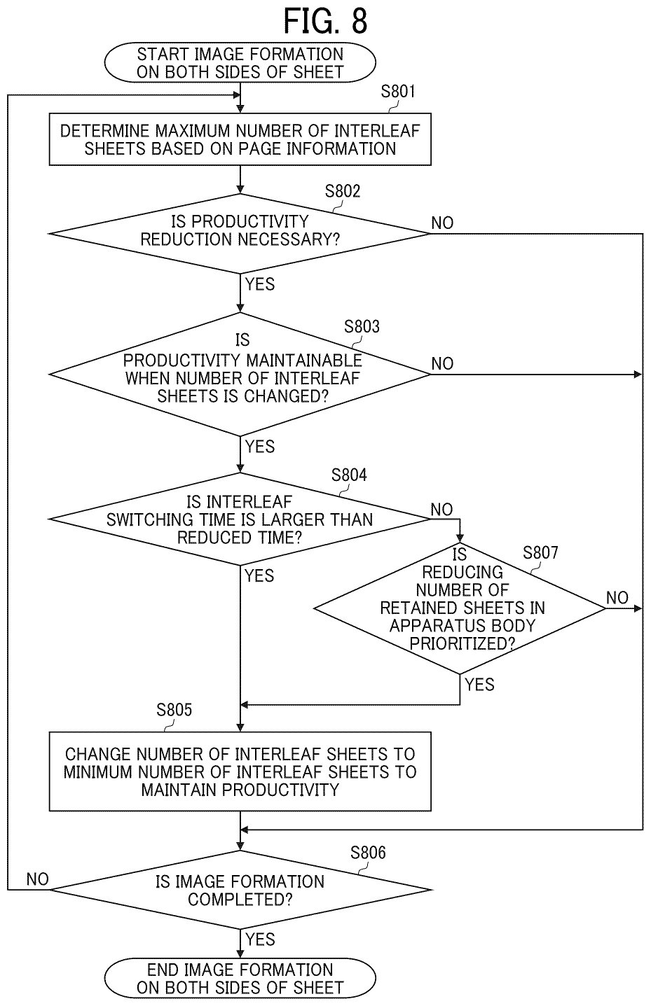

Based on the configuration described above, a description is given of the modification of the above-described embodiments with reference to the flowchart of FIG. 8. The flowchart illustrated in FIG. 8 partially overlaps the flowchart illustrated in FIG. 7 described above. However, some overlapping descriptions are described to distinguish the flowchart of FIG. 7 and the flowchart of FIG. 8.

First, the controller 50 of the MFP 1 determines the maximum number of interleaf sheets from the page information and sets the maximum number of interleaf sheets (step S801). At this time, the controller 50 uniquely determines the maximum number of interleaf sheets from the length of the conveyance path of the MFP 1, the linear velocity of the sheet conveyance, the productivity data (the number of sheets to be printed per unit time), which are determined in advance, and the sheet size determined by the page information.

Subsequently, the controller 50 determines whether to reduce the productivity (step S802). If the image forming process is a copying process, the controller 50 determines in step S802 whether the reduction of CPM is necessary. If the image forming process is a printing process, the controller 50 determines in step S802 whether the reduction of PPM is necessary.

Examples of factors for determining whether the productivity needs to be reduced in step S802 includes the condition of the fixing device 13. The details of the process of determining whether the production needs to be reduced are similar as those of step S702 described above. Thus, the detailed description thereof is omitted. If the controller 50 does not determine in step S802 that the productivity needs to be reduced (NO in step S802), the controller 50 sets the maximum number of interleaf sheets determined in step S801 and loops the processing until the image forming process defined in the job is completed (NO in step S806).

When the factor that caused the productivity reduction is solved as a result of reducing the productivity and the condition that requires the productivity reduction is not satisfied, the controller 50 cancels the productivity reduction and performs an operation based on a predetermined productivity.

When the condition that requires the productivity reduction is satisfied in step S802 (YES in step S802), the controller 50 determines the production reduction rate from, for example, the temperature condition of the MFP 1. Examples of methods of determining the productivity reduction rate include the reduction of CPM based on the temperature of the fixing device 13 and the change of the setting of the sheet interval based on the temperature of the transfer device 12.

Subsequently, the controller 50 determines whether the productivity is maintainable even when the number of interleaf sheets is reduced (step S803). The details of the determination process in step S803 are similar to the determination process in step S703 described above. Thus, the detailed description thereof is omitted.

If the productivity is not be maintainable even if the number of interleaf sheets is reduced in step S803 (NO in step S803), the controller 50 loops the processing until the image forming process specified in the job data is completed based on the setting of the maximum number of interleaf sheets determined in step S801 (NO in step S806).

In step S803, when the productivity is maintainable even if the number of interleaf sheets is reduced (YES in step S803), the controller 50 compares a time necessary for switching the number of interleaf sheets (switching time Tc) with a time reduced by switching the number of interleaf sheets (shortened time Ts). When the controller 50 determines that the shortened time Ts is smaller than the switching time Tc (YES in step S804), the controller 50 changes the number of interleaf sheets to the minimum number of interleaf sheets that can maintain the productivity after the productivity is reduced in accordance with the formula, “N≥{(T_duplex/T_paper)+1}/2”, as in step S704 (step S805). Then, the controller 50 loops the processing until the image forming process defined in the job data is completed (NO in step S806), and when the image forming process is completed (YES in step S806), the controller 50 completes the processing.

When the controller 50 determines that the shortened time Ts is not smaller than the switching time Tc (NO in step S804), the productivity reduction may be needed while the interleaf operation is set to perform the image forming process of duplex printing. At this time, the controller 50 determines whether the operator has set a setting (priority setting) in advance in which reducing the number of sheets P retained in the MFP 1 to be removed (step S807) is prioritized. If the controller 50 determines that the priority setting is not set in step S807 (NO in step S807), the controller 50 loops the processing until the image forming process defined in the job is completed based on the setting of the maximum number of interleaf sheets determined in step S801 (NO in step S806).

If the priority setting is set in step S807 (YES in step S807), the controller 50 changes the number of interleaf sheets to the minimum number of interleaf sheets that can maintain the productivity after the productivity is reduced in accordance with the formula, “N≥{(T_duplex/T_paper)+1}/2”, as in step S704 (step S805). Then, the controller 50 loops the processing until the image forming process defined in the job is completed (NO in step S806), and when the image forming process is completed (YES in step S806), the controller 50 completes the processing.

The priority setting in step S807 is assumed to be set in advance by the operator before the image forming process is started.

In step S807, when the controller 50 determines that the priority setting is set (YES in step S807), the controller 50 switches the setting of the number of interleaf sheets. At this time, when the number of sheets P retained in the MFP 1 is reduced to reduce the time and effort when a sheet jam occurs, the image forming process may be started again with the reduced number of interleaf sheets after all the retained sheets P are removed from the MFP 1.

As described above, the MFP 1 according to the present embodiment can select the minimum number of interleaf sheets that maintains the productivity, i.e., the productivity after the productivity is reduced, and perform the image forming process, when the productivity is reduced due to, for example, the condition of the fixing temperature while the image forming process is performed on both sides of the sheets P.

For example, in a printing condition before the productivity is reduced, the MFP 1 can perform the image forming process by the two-sheet interleaf operation when the productivity is maintainable under the two-sheet interleaf operation, instead of performing the image forming process by the three-sheet interleaf operation.

In other words, the MFP 1 according to the present embodiment can switch to the minimum number of interleaf sheets that can maintain the productivity after the productivity is reduced, when the productivity reduction occurs due to the condition of the fixing temperature during the duplex printing. As a result, the MFP 1 according to the present embodiment can reduce the number of sheets P retained in the MFP 1 when an abnormality occurs, reduce the time necessary to complete the image forming process, and reduce the printing time when productivity is reduced.

An image forming apparatus includes an image former, a conveyor, and a controller. The image former forms an image on a medium as an image-forming operation. The conveyor retains mediums for a preset retention number in the conveyor and sequentially conveys the medium to the image former based on a conveyance order of the medium determined by the preset retention number. The controller controls the image former and the conveyor to perform the image-forming operation, determines whether to reduce productivity of the image former based on a change in environment of the image-forming operation during the image-forming operation, and determines whether to reduce the preset retention number in response to a determination of reducing the productivity.

The controller also determines whether the productivity is maintainable based on the productivity after reducing the productivity and the preset retention number, and calculates the preset retention number at which the productivity is maintainable after reducing the productivity.

The controller also calculates the preset retention number at which the productivity is maintainable and controls the image former and the conveyor to perform the image-forming operation based on the preset retention number calculated, when the controller determines to reduce the productivity based on the change in environment of the image-forming operation, and the controller determines that the productivity is maintainable after reducing the preset retention number.

The image former includes a fixing device to fix an image on the medium. The controller also determines whether to reduce the productivity based on a change in temperature condition of the fixing device as the change of environment of the image-forming operation.

The image former includes a transferor to transfer an image to the medium. The controller also determines whether to reduce the productivity based on a change in temperature condition of the transferor as the change of environment of the image-forming operation.

Embodiments of the present disclosure are not limited to specific embodiments described above, and numerous additional modifications and modifications are possible in light of the teachings within the technical scope of the present disclosure. It is therefore to be understood that the disclosure of the present specification may be practiced otherwise by those skilled in the art than as specifically described herein. Such embodiments and variations thereof are included in the scope and gist of the embodiments of the present disclosure and are included in the embodiments described in claims and the equivalent scope thereof.

Aspects of the present disclosure are, for example, as follows.

### First Aspect

An image forming apparatus includes an image former, a conveyor, and a controller. The image former forms an image on a medium as an image-forming operation. The conveyor retains mediums for a preset retention number, i.e., a number of retained sheets, in the conveyor and sequentially conveys the medium to the image former based on a conveyance order of the medium determined by the preset retention number. The controller controls the image former and the conveyor to perform the image-forming operation, determines whether to reduce productivity of the image former based on a change in environment of the image-forming operation during the image-forming operation, and determines whether to reduce the preset retention number in response to a determination of reducing the productivity.

### Second Aspect

In the image forming apparatus according to the first aspect, the controller also determines whether the productivity is maintainable based on the productivity after reducing the productivity and the preset retention number, and calculates the preset retention number at which the productivity is maintainable after reducing the productivity.

### Third Aspect

In the image forming apparatus according to the second aspect, the controller also calculates the preset retention number at which the productivity is maintainable and controls the image former and the conveyor to perform the image-forming operation based on the preset retention number calculated, when the controller determines to reduce the productivity based on the change in environment of the image-forming operation, and the controller determines that the productivity is maintainable after reducing the preset retention number.

### Fourth Aspect

In the image forming apparatus according to any one of the first to third aspect, the image former includes a fixing device to fix an image on the medium. The controller also determines whether to reduce the productivity based on a change in temperature condition of the fixing device as the change of environment of the image-forming operation.

### Fifth Aspect

In the image forming apparatus according to any one of the first to fourth aspect, the image former includes a transferor to transfer an image to the medium. The controller also determines whether to reduce the productivity based on a change in temperature condition of the transferor as the change in environment of the image-forming operation.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming apparatus comprising:
an image former to form an image on a medium as an image-forming operation;
a conveyor to:
retain mediums for a preset retention number in the conveyor; and
sequentially convey the medium to the image former based on a conveyance order of the medium determined by the preset retention number; and
circuitry configured to:
control the image former and the conveyor to perform the image-forming operation;
determine whether to reduce productivity of the image former based on a change in environment of the image-forming operation during the image-forming operation; and
determine whether to reduce the preset retention number in response to a determination of reducing the productivity.

2. The image forming apparatus according to claim 1,
wherein the circuitry is further configured to:
determine whether the productivity is maintainable based on:
the productivity after reducing the productivity; and
the preset retention number; and
calculate the preset retention number at which the productivity is maintainable after reducing the productivity.

3. The image forming apparatus according to claim 2,
wherein the circuitry is further configured to:
calculate the preset retention number at which the productivity is maintainable; and
control the image former and the conveyor to perform the image-forming operation based on the preset retention number calculated,
when the circuitry determines to reduce the productivity based on the change in environment of the image-forming operation, and
the circuitry determines that the productivity is maintainable after reducing the preset retention number.

4. The image forming apparatus according to claim 1,
wherein the image former includes a fixing device to fix an image on the medium,
the circuitry is further configured to determine whether to reduce the productivity based on a change in temperature condition of the fixing device as the change of environment of the image-forming operation.

5. The image forming apparatus according to claim 1,
wherein the image former includes a transferor to transfer an image to the medium,
the circuitry is further configured to determine whether to reduce the productivity based on a change in temperature condition of the transferor as the change of environment of the image-forming operation.
